(19) United States
(12) Patent Application Publication
(10) Pub. No.: US 2010/0302206 A1
(43) Pub. Date: Dec. 2, 2010

(54) TOUCH SENSING DISPLAY AND TOUCH PANEL THEREOF

(76) Inventors: Ming-Chang YU, Tai Chung City (TW); Hen-Ta Kang, Tai Chung City (TW); Hsi-Rong Han, Tai Chung County (TW)

Correspondence Address: Muncy, Geissler, Olds & Lowe, PLLC, 4000 Legato Road, Suite 310, FAIRFAX, VA, 22033, US

(21) Appl. No.: 12/791,324

(22) Filed: Jun. 1, 2010

(30) Foreign Application Priority Data
Jun. 1, 2009 (TW) 098118137

(51) Int. Cl. G06F 3/045; G06F 3/041

(52) U.S. Cl. 345/174; 345/173

(57) ABSTRACT

A touch panel includes a transparent substrate and a touch sensor. The transparent substrate has a cavity formed on one surface of the transparent substrate, and the touch sensor is provided inside the cavity of the transparent substrate.

### BACKGROUND OF THE INVENTION

(a) Field of the Invention

The invention relates to a touch panel and a touch sensing display.

(b) Description of the Related Art

In general, a liquid crystal display does not have a touch sensing function and thus is provided with a touch panel on its surface to produce a touch-sensing LCD. FIG. 1 shows a cross-section of a conventional touch panel and a conventional liquid crystal display panel. Referring to FIG. 1, the touch panel 12 is a resistive or capacitive touch panel, and it is basically composed of two substrates each with electrode patterns. Electrode patterns 126 are provided on a first substrate 122, and electrode patterns 128 are provided on a second substrate 124 opposite the first substrate 122. Generally, alignment directions of the electrode pattern 126 and the electrode pattern 128 are perpendicular to each other. Further, the liquid crystal display panel includes a color filter 14, an active array substrate 16, and a liquid crystal layer 18.

### BRIEF SUMMARY OF THE INVENTION

In light of the above-mentioned problem, one object of the invention is to provide a touch sensing device capable of performing touch-sensing operations and having a reduced thickness approaching the thickness of a transparent substrate.

According to an embodiment of the invention, a touch panel includes a transparent substrate and a touch sensor. The transparent substrate has a cavity formed on one surface of the transparent substrate, and the touch sensor is provided inside the cavity of the transparent substrate.

According to another embodiment of the invention, a touch sensing display includes a touch panel and a display unit. The transparent substrate has a cavity formed on one surface of the transparent substrate, and the touch sensor is provided inside the cavity of the transparent substrate. The display unit is provided on a first surface of the touch sensor, where the first surface is opposite a second surface of the touch sensor and the transparent substrate covers the second surface of the touch sensor.

Other objectives and advantages of the invention can be further understood through the disclosed technical characteristics. Accompanying with the following figures, examples and claims, the above and other objectives and advantages of the invention will be described in details in the following.

### BRIEF DESCRIPTION OF THE DRAWINGS

FIG. 1 shows a cross-section illustrating a conventional liquid crystal display panel having a touch sensing function.

FIG. 2 shows a cross-section illustrating a touch panel according to one embodiment of the invention.

FIG. 3A-3E show flow charts illustrating a method of manufacturing a touch panel according to one embodiment of the invention.

FIG. 4 shows a cross-section illustrating a touch sensing display according to one embodiment of the invention.

FIG. 5 shows a cross-section illustrating a touch sensing display according to one embodiment of the invention.

FIG. 6 shows a schematic diagram illustrating a liquid crystal touch sensing display according to one embodiment of the invention.

FIG. 7 shows a schematic diagram illustrating a flat panel touch sensing display according to one embodiment of the invention.

FIG. 8 shows a schematic diagram illustrating a liquid crystal touch sensing display according to one embodiment of the invention, where the touch sensor has a double-layered electrode structure.

FIG. 9 shows a top view illustrating the electrode layout of the touch sensor shown in FIG. 8.

FIG. 10 shows a schematic diagram illustrating a liquid crystal touch sensing display according to one embodiment of the invention, where the touch sensor has a single-layered electrode structure.

FIG. 11 shows a cross-section cut along the A-A line shown in FIG. 10.

FIG. 12 shows a top view illustrating a grid shape of the insulation layer shown in FIG. 10.

### DETAILED DESCRIPTION OF THE INVENTION

FIG. 2 shows a cross-section illustrating a touch panel according to one embodiment of the invention. The touch panel 60 includes a transparent substrate 61, and the transparent substrate 61 is a flexible or a non-flexible substrate, such as a glass substrate or a plastic substrate. One surface of the transparent substrate 61 is carved to form a cavity 62. A touch sensor 63 is provided inside the cavity 62 of the transparent substrate 61. The touch sensor 63 may be a capacitive touch sensor, a resistive touch sensor, an inductive touch sensor, an optical touch sensor or the like. A capacitive touch sensor is taken as an example and described in the following.

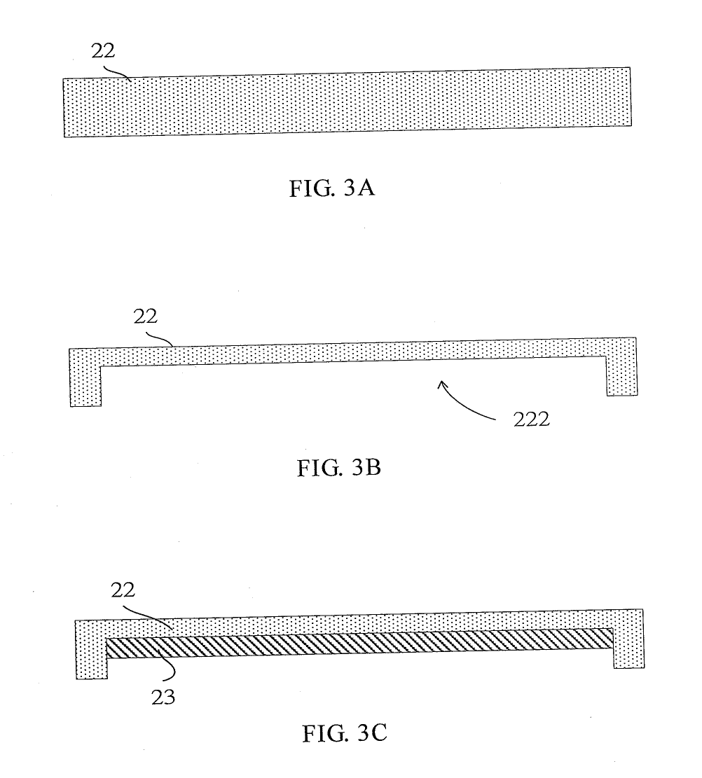

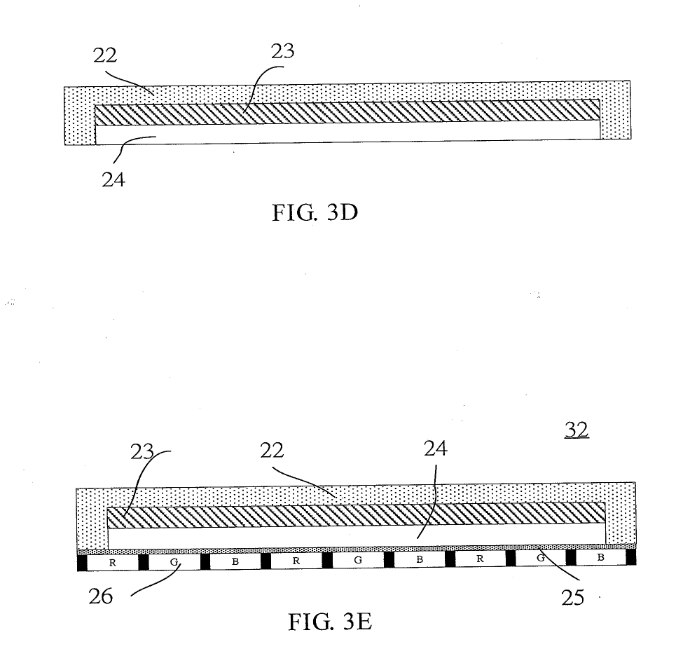

FIGS. 3A-3C show flow charts illustrating a method of manufacturing a touch panel according to one embodiment of the invention. At first, as shown in FIG. 3A, a transparent substrate 22 is prepared. Then, the transparent substrate 22 is carved to form a cavity 222 shown in FIG. 3B. For example, a hydrofluoric acid (HF) etchant is used to etch a glass substrate to form a cavity. The thickness of the cavity is not limited and can be selected according to the actual demand. Then, as shown in FIG. 3C, a capacitive touch sensor 23 is formed on the bottom of the cavity 222.

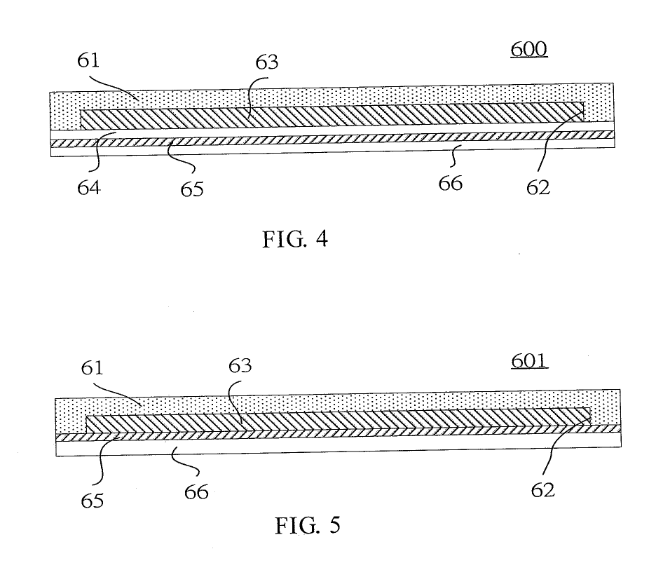

The touch panel of the invention may be combined with various display units. Referring to FIG. 4, a display unit is provided on a first surface of the touch sensor 63, the first surface is opposite a second surface of the touch sensor 63, and the transparent substrate 61 covers the second surface of the touch sensor 63 to thereby form a touch sensing display 600. The display unit may include an insulation layer or a top transparent substrate 64, a bottom transparent substrate 66, and a display layer 65 provided between the top transparent substrate 64 and the bottom transparent substrate 66. The display layer 65 may be a liquid crystal layer, an electro-phoretic display (EPD) layer, an electro-wetting display (EWD) layer, an organic light emitting diode (OLED) layer or the like, so that the top transparent substrate 64, the bottom transparent substrate 66, and the display layer 65 together form a liquid crystal display, an electro-phoretic display, an electro-wetting display, or an organic light emitting diode (OLED) display.

Further, FIG. 5 shows an alternate embodiment of a touch sensing display 601. Referring to FIG. 5, the display unit includes a bottom transparent substrate 66 and a display layer 65. The bottom transparent substrate 66 may be an active array transparent substrate, a glass substrate, or a color filter, and the display layer 65 may be a liquid crystal layer, an electro-phoretic display layer, an electro-wetting display layer, an organic light emitting diode layer, or the like. The display layer 65 is provided between the transparent substrate 61 and the bottom transparent substrate 66.

Furthermore, referring to FIGS. 3D and 3E, a multiple-layered structure may be additionally provided in the touch panel 60, where a first insulation layer 24 covers the capacitive touch sensor 23 to fill up the cavity 222, as shown in FIG. 3D. The first insulation layer 24 may be an organic layer, an inorganic layer, or an organic-and-inorganic-blended layer. The first insulation layer 24 may be formed by a single process or a plurality of processes. Besides, the side wall of the cavity 222 functions as a retaining wall to support the first insulation layer 24 and thus allow for sufficient thickness of the first insulation layer 24. In other words, if the cavity 222 do not exist, it is difficult for the first insulation layer 24 to have a sufficient thickness of such as 20-100 um. The cavity 222 plays an important role in supporting the first insulation layer 24. Note the thickness of the first insulation layer 24 is not limited to be 20-100 um according to the invention.

Finally, a shielding layer 25 and a color filter layer 26 are formed in succession, as shown in FIG. 3E. The shielding layer 25 is made of an electrically conductive material and may be a transparent electrode spreading over an entire plane or a grid-shaped electrode. The shielding layer 25 may prevent the sensing operations of the capacitive touch sensor 23 from being interfered by external noises that come from a variety of signals such as scan signals, data signals or Vcom signals of a display. However, the shielding layer 25 is not essential and may be omitted depending on actual situations, such as the first insulation layer 24 being thick enough to block external noises. A color filter 32 is provided on the first insulation layer 24 or the shielding layer 25 to achieve a touch sensing display.

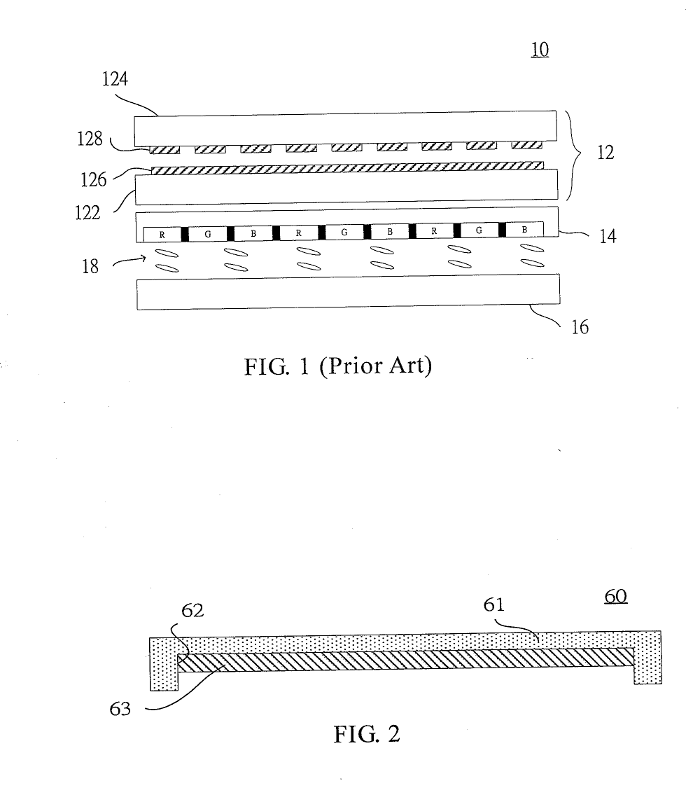

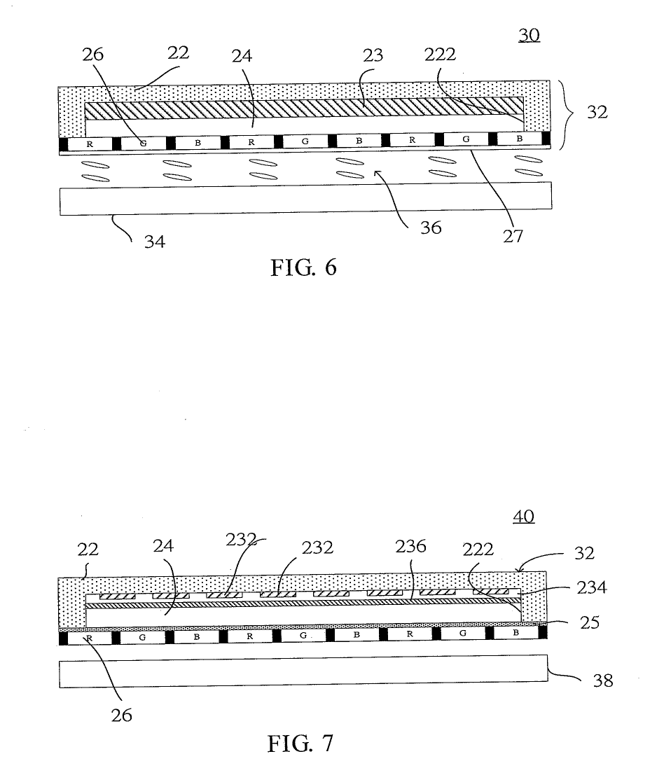

In one embodiment, a color filter 32 with touch sensing functions can be combined with various display panels. FIG. 6 shows a cross-section illustrating a liquid crystal touch sensing display 30 according to one embodiment of the invention. The color filter 32 is provided opposite an active array substrate 34, and a liquid crystal layer 36 is provided between the color filter 32 and the active array substrate 34. Besides, since a common electrode layer 27 is provided on the color filter layer 26, the shielding layer 25 is preferably provided between the common electrode layer 27 and the capacitive touch sensor 23 to prevent sensing operations of the capacitive touch sensor 23 from being interfered by signals from the common electrode layer 27. As shown in FIG. 6, compared with the four-layered structure of a conventional design (FIG. 1), the number of substrates according to an embodiment of the invention is reduced to two. That is, the three substrates 14, 122, and 124 of the color filter 14 and the touch panel 12 shown in FIG. 1 are integrated into one transparent substrate 22 shown in FIG. 6. Therefore, the overall thickness is greatly reduced to achieve a thin touch sensing display.

Certainly, the touch panel of the invention can also be used in any other display panel 38, such as an electro-phoretic display (EPD) panel, an electro-wetting display (EWD) panel, an organic light emitting diode panel or the like. The structure of the above mentioned flat panel display panel 38 is well known to those who are skilled in the art and thus its details will not be given hereinafter. FIG. 7 shows a cross-section illustrating a flat touch sensing display panel 40 according to one embodiment of the invention. If the flat display panel 38 is an OLED panel, a white light OLED panel is preferred.

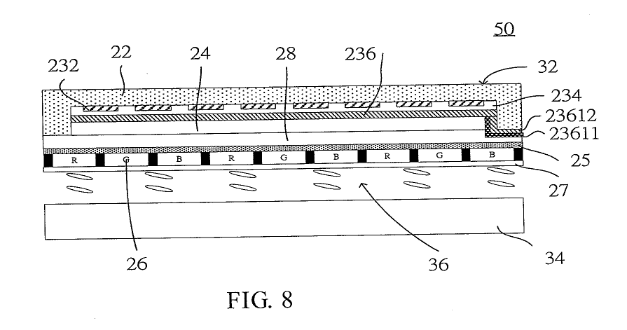

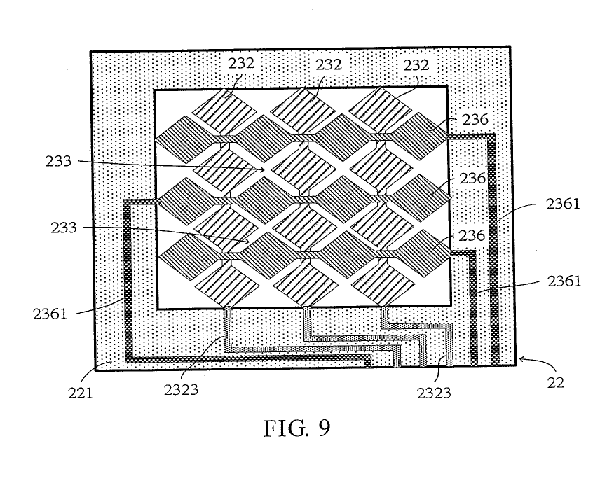

Please also refer to FIG. 8 and FIG. 9. FIG. 8 shows a liquid crystal touch sensing display 50 where the touch sensor 23 has a double-layered electrode structure. FIG. 9 shows a top view illustrating the electrode layout of the touch sensor 23 shown in FIG. 8. The capacitive touch sensor 23 includes a plurality of first electrodes 232 arranged along a first direction and a plurality of second electrodes 236 arranged along a second direction intersected by the first direction. The first electrodes 232 are electrically insulated from the second electrodes 236 by a gap 233 between them. A second insulation layer 234 is provided between the first electrodes 232 and the second electrodes 236 and covers the first electrodes 232. Preferably, the first direction and the second direction are perpendicular to each other. Further, the first electrodes 232 and the second electrodes 236 are not limited to the shape shown in the figure. For example, they may be rectangular strip structures or have any other shape capable of achieving the same function.

Besides, since the first electrodes 232 and the second electrodes 236 are provided inside the cavity 222 to form the sensor having a sensing function, the cavity 222 is defined as a sensing area, and the peripheral portion of the transparent substrate 22 that excludes the cavity 222 is defined as a non-sensing area 221. In addition, the capacitive touch sensor 23 further comprises a plurality of first signal lines 2323 and a plurality of second signal lines 2361. Each of the first signal lines 2323 is connected to the corresponding first electrode 232, and the first signal line 2323 extends from the cavity 222 towards outside to the non-sensing area 221 on the transparent substrate 22. Similarly, each of the second signal lines 2361 is connected to the corresponding second electrode 236 and the second signal line 2361 extends from the cavity 222 towards outside to the non-sensing area 221 on the transparent substrate 22. The material of the first signal lines 2323 and the second signal lines 2361 is metal, indium tin oxide (ITO), or indium zinc oxide (IZO). As shown in FIG. 8, the second signal lines 2361 are formed by laminating a metallic layer 23611 on a layer 23612 of indium tin oxide (ITO); that is, the second signal lines 2361 are composed of a double-layered structure. Alternatively, the second signal lines 2361 can also be formed by laminating a layer of indium tin oxide (ITO) on a metallic layer. Preferably, a third insulation layer 28 is provided on the first insulation layer 24 to cover the first signal lines 2323 and the second signal lines 2361 in order to electrically insulate the shielding layer 25 from the signal lines 2323 and 2361. However, if the shielding layer 25 is selectively omitted, the third insulation layer 28 can be selectively remained or omitted. Furthermore, the non-sensing area 221 is provided with a light shielding layer (not shown) between the signal lines 2323 (2361) and the substrate 22.

As shown in FIG. 9, each of the first signal lines 2323 is connected to the lower end of the corresponding first electrode 232 and extends to the lower side of the non-sensing area 221. On the other hand, some of the second signal lines 2361 connect to the right end of the corresponding second electrodes 236, and the rest of the second signal lines 2361 are connected to the left end of the corresponding second electrodes 236 and besides both extend to the lower side of the non-sensing area 221. Such circuit layout allows for a minimum range of the widths of the left and right sides of the transparent substrate 22 occupied by the non-sensing area 221. However, the above circuit layout is only as an example and is not used to limit the circuit layout of the signal lines of the invention.

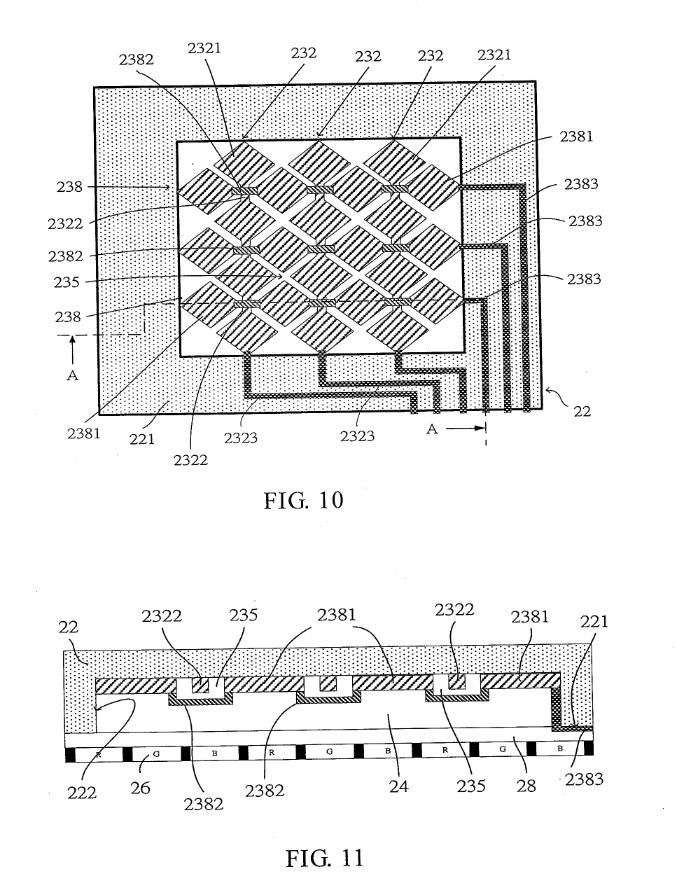

Please both refer to FIG. 10 and FIG. 11. FIG. 10 shows a top view schematic diagram illustrating the circuit layout of the touch sensor of a liquid crystal touch sensing display according to another embodiment of the invention. FIG. 11 shows a cross-section cut along the A-A line shown in FIG. 10. The difference between the capacitive touch sensor 23 in this embodiment and that in the previous embodiment is that the second insulation layer 235 covers only part of the first electrodes 232, and that the first electrodes 232 and the second electrodes 236 belong to a same layer. (That is, the first electrodes 232 and the second electrodes 236 are formed by the same patterning process.)

Specifically, each of the first electrodes 232 is formed by connecting a plurality of first sensing pads 2321 and a plurality of first electrically conductive lines 2322 in series. Each of the first electrically conductive lines 2322 is used to connect two adjacent first sensing pads 2321. Similarly, each of the second electrodes 238 is formed by connecting a plurality of second sensing pads 2381 and a plurality of second electrically conductive lines 2382 in series. Besides, the second insulation layer 235 may have two types of layouts. The first type is that the second insulation layer 235 covers only the first electrically conductive lines 2322 and neighboring areas, and then the second electrically conductive lines 2382 are provided and laminated on the second insulation layer 235. Alternatively, the second type is that the second insulation layer 235 covers the first electrically conductive lines 2322 and fills up the gaps between the first electrodes 232 and the second electrodes 238.

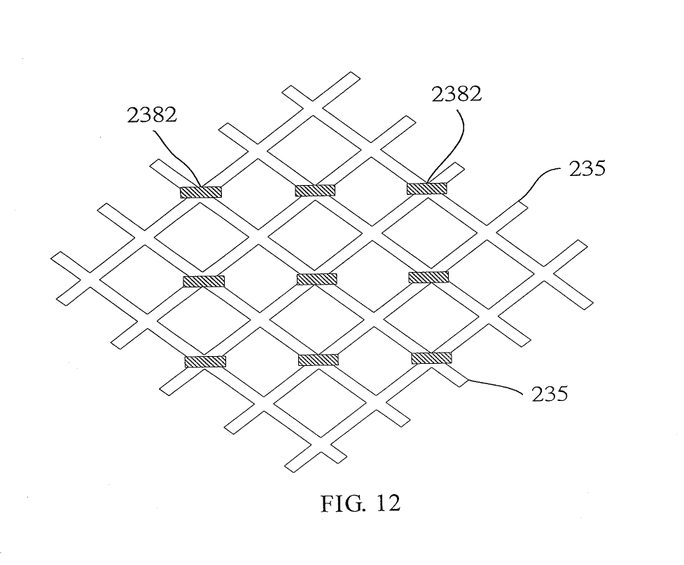

The second type is shown in FIG. 12. The top view of FIG. 12 shows that the second insulation layer 235 forms a grid-shaped pattern on an entire surface, and the second electrically conductive lines 2383 ride across the second insulation layer 235 to connect adjacent second sensing pads 2381 (not shown) in series. The grid-shaped pattern of the second insulation layer 235 that spreads on an entire surface has the advantage of providing optical compensation to reduce or eliminate retained shadows. The retained shadows are formed because the refractive indexes of the first electrodes 232 and the second electrodes 238 are different from that of the gaps and thus the boundary of the electrodes is visually seen. This should be avoided as much as possible. If the material of the second insulation layer 235 is selected to have a similar refractive index as that of the first electrodes 232 and the second electrodes 238, accompanying with the above grid shaped layout structure shown in FIG. 12, the retained shadows can be reduced or eliminated.

Referring to both FIG. 10 and FIG. 11, the first insulation layer 24 directly covers the first electrodes 232 (the first sensing pads 2321 and the first electrically conductive lines 2322) and the second electrodes 238 (the second sensing pads 2381 and the second electrically conductive lines 2382). The capacitive touch sensor 23 further includes a plurality of first signal lines 2323 and a plurality of second signal lines 2383. Each of the first signal lines 2323 is connected to the corresponding first electrode 232 and the first signal line 2323 extends from the cavity 222 towards outside to the non-sensing area 221 on the transparent substrate 22. Each of the second signal lines 2383 is connected to the corresponding second electrode 238 and the second signal line 2383 extends from the cavity 222 towards outside to the non-sensing area 221 on the transparent substrate 22. The material of the first signal lines 2323 and the second signal lines 2383 is metal, indium tin oxide (ITO), or indium zinc oxide (IZO). As shown in FIG. 11, the second signal lines 2383 are formed by a single layer of metallic material, but the second signal lines 2383 may also be formed by a double-layered structure (not shown) of laminating a metallic material and a transparent conductive material. However, the constituting material is not limited to metal. Preferably, a third insulation layer 28 is provided on the first insulation layer 24 as a planarization layer to cover the first signal lines 2323 and the second signal lines 2383. Note the third insulation layer 28 can be omitted and is not an essential component.

As shown in FIG. 10, each of the first signal lines 2323 is connected to the lower end of the corresponding first electrode 232 and extends to the lower side of the non-sensing area 221. The second signal lines 2383 connect to the right end of the corresponding second electrodes 236 and extend to the lower side of the non-sensing area 221. Such circuit layout allows for gathering signal lines together on a same place. However, the above circuit layout is only as an example and is not used to limit the circuit layout of the signal lines of the invention.

Although the present invention has been fully described by the above embodiments, the embodiments should not constitute the limitation of the scope of the invention. Various modifications or changes can be made by those who are skilled in the art without deviating from the spirit of the invention. Any embodiment or claim of the present invention does not need to reach all the disclosed objects, advantages, and uniqueness of the invention. Besides, the abstract and the title are only used for assisting the search of the patent documentation and should not be construed as any limitation on the implementation range of the invention.

What is claimed is:

1. A touch panel, comprising:
a transparent substrate having a cavity formed on one surface of the transparent substrate; and
a touch sensor provided inside the cavity of the transparent substrate.

2. The touch panel according to claim 1, wherein the transparent substrate is a flexible or a non-flexible substrate.

3. The touch panel according to claim 1, wherein the transparent substrate is a glass substrate or a plastic substrate.

4. The touch panel according to claim 1, wherein the touch sensor is a capacitive touch sensor, a resistive touch sensor, an inductive touch sensor, and an optical touch sensor.

5. The touch panel according to claim 1, further comprising a first insulation layer substantially filled in the cavity and covering the touch sensor.

6. The touch panel according to claim 5, further comprising a color filter layer provided on the first insulation layer.

7. The touch panel according to claim 6, further comprising a transparent shielding layer provided between the color filter layer and the first insulation layer and the transparent shielding layer is made of an electrically conductive material.

8. The touch panel according to claim 5, wherein the touch sensor is a capacitive touch sensor and the capacitive touch sensor comprises:
a plurality of first electrodes arranged along a first direction; and
a plurality of second electrodes arranged along a second direction intersected by the first direction.

9. The touch panel according to claim 8, wherein the capacitive touch sensor further comprises a second insulation layer covering the first electrodes and provided between the first electrodes and the second electrodes.

10. The touch panel according to claim 8, wherein the capacitive touch sensor further comprises a second insulation layer covering part of the first electrodes and provided on the same layer as the first electrodes and the second electrodes.

11. The touch panel according to claim 10, wherein each of the first electrodes comprises a plurality of first sensing pads and a plurality of first electrically conductive lines connected to the first sensing pads, each of the second electrodes comprises a plurality of second sensing pads and a plurality of second electrically conductive lines connected to the second sensing pads, the second insulation layer covers the first electrically conductive lines and fills up the gaps between the first electrodes and the second electrodes, and the first insulation layer covers the first electrodes and the second electrodes.

12. The touch panel according to claim 8, wherein the capacitive touch sensor further comprises:
a non-sensing area;
a plurality of first signal lines connected to the corresponding first electrodes, wherein the first signal lines extend from the inside of the cavity to the non-sensing area;
a plurality of second signal lines connected to the corresponding second electrodes, wherein the second signal lines extend from the inside of the cavity to the non-sensing area; and
a third insulation layer provided on the first insulation layer and covering the first signal lines and the second signal lines.

13. The touch panel according to claim 12, wherein the first electrodes, the second electrodes, the first signal lines, and the second signal lines are made of metal, indium tin oxide (ITO), or indium zinc oxide (IZO).

14. A touch sensing display, comprising:
a touch panel comprising:
a transparent substrate having a cavity formed on one surface of the transparent substrate; and
a touch sensor provided inside the cavity of the transparent substrate; and
a display unit provided on a first surface of the touch sensor, wherein the first surface is opposite a second surface of the touch sensor and the transparent substrate covers the second surface of the touch sensor.

15. The touch sensing display according to claim 14, wherein the display unit comprises a top transparent substrate, a bottom transparent substrate opposite the top transparent substrate, and a display layer between the top transparent substrate and the bottom transparent substrate.

16. The touch sensing display according to claim 15, wherein the display layer is a liquid crystal layer, an electro-phoretic display layer, an electro-wetting display layer, or an organic light emitting diode layer.

17. The touch sensing display according to claim 15, wherein the bottom transparent substrate is an active array transparent substrate, a glass substrate, or a color filter substrate.

18. The touch sensing display according to claim 14, wherein the display unit comprises a bottom transparent substrate and a display layer provided between the bottom transparent substrate and the transparent substrate.

19. The touch sensing display according to claim 18, wherein the display layer is a liquid crystal layer, an electro-phoretic display layer, an electro-wetting display layer, or an organic light emitting diode layer.

20. The touch sensing display according to claim 18, wherein the bottom transparent substrate is an active array transparent substrate, a glass substrate, or a color filter substrate.

21. The touch sensing display according to claim 14, wherein the touch panel further comprises an insulation layer substantially filled in the cavity and covering the touch sensor, and the display unit is provided on the insulation layer.

22. The touch sensing display according to claim 21, further comprising a transparent shielding layer provided between the touch panel and the insulation layer, wherein the transparent shielding layer is electrically conductive.
